(19) United States
(12) Patent Application Publication
(10) Pub. No.: US 2026/0370553 A1
(43) Pub. Date: Nov. 19, 2026

(54) DYNAMICALLY GENERATING NETWORK POLICIES BASED ON NETWORK BEHAVIOR

(71) Applicant: Hewlett Packard Enterprise Development LP, Spring, TX (US)

(72) Inventors: Mohan Parthasarathy, Santa Clara, CA (US); Ziad Hadi, Milton (CA); Unum Sarfraz, Santa Clara, CA (US); Tejas Shetty, San Jose, CA (US)

(21) Appl. No.: 19/212,135

(22) Filed: May 19, 2025

(51) Int. Cl. H04L 41/0894; H04L 41/16; H04L 43/02

(52) U.S. Cl. CPC H04L 41/0894; H04L 41/16; H04L 43/02

(57) ABSTRACT

A method may include monitoring network traffic data associated with communication packets transmitted from source endpoint devices to destination endpoint devices via a network over a period of time. The network traffic data may include source roles associated with the source endpoint devices connecting to the network and destination roles associated with the destination endpoint devices. The method may then include generating a network policy based on the monitored network traffic data. The network policy may include a set of rules governing access rights of the source endpoint devices with respect to accessing the destination endpoint devices based on a relationship between a source role and a destination role of each of the communication packets.

The network policy may then be sent to network devices, such that the network devices may manage access requests to the destination endpoint devices received from the source endpoint devices based on the network policy.

### BACKGROUND

Network policies may include rules that manage a client device's access to other devices on a network. The network policies may be generated based on a number of properties associated with the client device, the network, and the like. However, as these properties change, the network policies may not be updated to reflect the changes in the properties.

### DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example system that includes a policy management system that monitors network traffic data, in accordance with aspects of the present disclosure;

FIG. 2 illustrates an example flow chart of a method for generating a proposed network policy for a network device, in accordance with aspects of the present disclosure;

FIG. 3 illustrates an example flow chart of a method for modifying a proposed network policy, in accordance with aspects of the present disclosure;

FIG. 4 illustrates an example flow chart of a method for updating a network policy based on rejected communication packets, in accordance with aspects of the present disclosure;

FIG. 5 illustrates a block diagram illustrating a policy management system with a processor and a storage that performs one or more of the methods described herein, in accordance with aspects of the present disclosure; and

FIG. 6 illustrates a block diagram illustrating a network device with a processor and a storage that performs one or more the methods described herein, in accordance with aspects of the present disclosure.

### DETAILED DESCRIPTION

Network policies may include a set of rules that governs access rights for various endpoint devices within a network, access rights to other devices within the network, and the like. Network policies may be generated based on a variety of factors. For example, network policies may be dictated based on an identity (e.g., source internet protocol (IP) address) of a source endpoint device initiating a communication request in the network, based on an identity (e.g., destination Internet Protocol (IP) address) of a destination endpoint device facilitating the communication request, and the like. In the known techniques, after the network policies are generated, they are rarely modified or updated. Indeed, in order to continually address new network security concerns, additional sets of rules should be regularly added to account for the new network security concerns. However, these additional sets of rules are not often added by network administrators. In addition, when the network administrators do periodically update these network policies, they may do so in inconsistent ways, thereby making the network policies increasingly complex and difficult to maintain.

To better maintain and manage network policies, the techniques described herein may include dynamically generating and updating network policies based on monitored network traffic at different endpoint devices based on roles associated with the respective endpoint devices during a respective network communication session. That is, each endpoint device engaged in a communication activity may be associated with a particular role (e.g., source role, destination role) or a set of rights within the network, and the relationship between the roles of the endpoint devices engaged in the communication activity and a type of request associated with the communication activity may be used to generate a network policy governing communications between the respective endpoint devices.

In order to generate and dynamically update a network policy, a policy management system may monitor communications or network traffic at different endpoint devices in a network over a period of time (e.g., 30 days) to generate a baseline network activity model. The baseline network activity model may represent expected network traffic for the endpoint devices in the network over the period of time. In addition to being representative of the network traffic, the network activity model may include information related to the roles of different endpoint devices engaging in a respective communication activity. For instance, a source endpoint device connecting to a network and transmitting a communication packet may be associated with a source role, which may be related to a user profile operating the source endpoint device, a location of the source endpoint device within an enterprise, or the like. As the source endpoint device accesses different network devices via the network, each destination endpoint device (e.g., server, storage, database) being accessed by the source endpoint device may be mapped to a respective destination role based on a type of request (e.g., data access request) being facilitated, a type of device being accessed, and the like. As such, a network device communicatively coupled to the destination endpoint device may receive a communication packet requesting that the source endpoint device have access to a particular type of data, datasets located in a particular storage component, or the like of the destination endpoint device. The information related to the data access request from the source endpoint device, the type of device requested for access by the source endpoint device, and other properties of the destination endpoint device may correspond to the destination role of the destination endpoint device. Over the period of time, the policy management system may monitor the network traffic between various endpoint devices (e.g., source endpoint device, destination endpoint device) with respect to the various combinations of source roles and destination roles related to the respective communication activities.

The monitored network traffic may be used to generate the baseline network activity model that represents expected network traffic between source and destination endpoint devices with respect to each source role and destination role combination of a respective communication packet or activity. The policy management system may then generate a proposed network policy for the network devices of the network based on the baseline network activity model. In this way, the proposed network policy may provide a set of rules that may govern a source endpoint device's access rights to a destination endpoint device based on the expected network traffic between source and destination endpoint devices relative to their respective roles. After generating the proposed network policy, the policy management system may present the proposed network policy to a user (e.g., network administrator) via a user's device. The user may modify aspects of the proposed network policy, and the resulting network policy may be sent to various network devices in the network to manage network access of various source and destination endpoint devices based on a role-to-role relationship corresponding to the source endpoint device and the destination endpoint device of a respective communication activity. That is, the network devices may manage access to destination endpoint devices based on an understanding of the source role and the destination role of a source endpoint device and a destination endpoint device of a particular communication activity. As a result, the current techniques provide enhanced security in communications within networks, while allowing network polices to be dynamically updated over time.

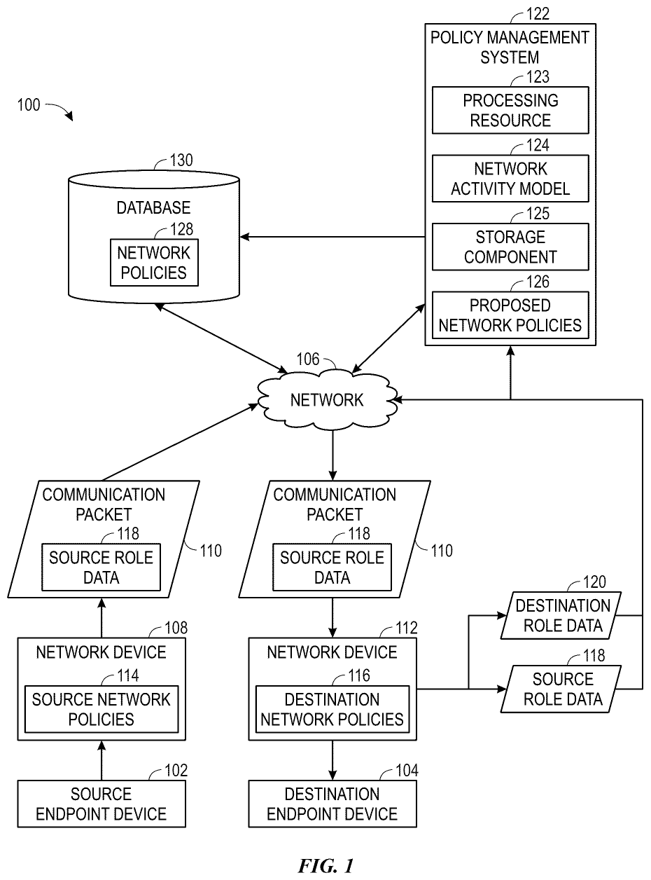

FIG. 1 illustrates a system 100 in which a source endpoint device 102 and a destination endpoint device 104 may be communicatively coupled to each other via a network 106. The network 106 may include any suitable network that facilitates communication between network devices, computing systems, electronic devices, and the like. The network 106 may enable various network devices to exchange data and share resources between each other. By way of example, the network 106 may include routers, switches, and other traffic directing devices to control the flow of data between senders and recipients. The network 106 may include a wired network, a wireless network, or both. For instance, the network 106 may include a Local Area Network (LAN), a Wide Area Network (WAN), the Internet, an Intranet, and the like.

The source endpoint device 102 and the destination endpoint device 104 may be any type of electronic device that communicates via the network 106. For example, the source endpoint device 102 and the destination endpoint device 104 may include a laptop, personal computer, server, database, and the like. The source endpoint device 102 and the destination endpoint device 104 may provide data to one another via data packets transmitted through the network 106. For example, the source endpoint device 102, which may be a client device, may send a request for data stored on the destination endpoint device 104 to a network device 108. The network device 108 may forward a communication packet 110 via the network 106 to the destination endpoint device 104. The destination endpoint device 104 may receive the communication packet 110 via a network device 112, which may facilitate data access requests to the destination endpoint device 104.

The network devices 108 and 112 may be any type of hardware and/or software device on a data path between the source endpoint device 102 and the destination endpoint device 104. That is, each of the network devices 108 and 112 may include at least one processing resource, at least one non-transitory machine-readable storage medium, and corresponding instructions. The network devices 108 and 112 may be an intermediate data processing device (e.g., computer), network access device (e.g., an access point), and/or a data forwarding component (e.g., a network gateway, network router and/or network switch). The network devices 108 and 112 may include respective source network policies 114 and destination network policies 116 that may indicate particular actions to implement when criteria associated with received communication packets are met. For example, specified actions of the source network policies 114 and/or the destination network policies 116 may include logging an indication of the communication packet, dropping the communication packet (e.g., in lieu of forwarding the received packet to its intended destination), performing deep packet inspection (DPI) on the received communication packet, routing the communication packet to a device, and the like.

The criteria of the source network policies 114 and/or the destination network policies 116 may include, for example, criteria associated with a source of the communication packet 110, criteria associated with a destination of the communication packet 110, and/or criteria associated with the type of communication packet itself. For example, with respect to source and/or destination criteria, the criteria may include a particular Internet Protocol (IP) address, a particular role, and/or other characteristic of the source and/or destination that is identifiable by the network devices 108 and/or 112. With respect to data packet criteria, the data packet criteria may include particular characteristics of the data packets, such as a particular application, particular ports, particular certificate and/or secure hash algorithm (SHA) exchanges, particular universal resource locators (URLs) and/or Server Name Identification (SNI) accesses, a particular version(s) of Transport Layer Security (TLS) and/or Secure Sockets Layer (SSL), and/or other particular characteristics identifiable by the network devices 108 and/or 112. When the network devices 108 and/or 112 identify that the criteria of the source network policies 114 and/or the destination network policies 116 are fully satisfied, the network devices 108 and/or 112 may may trigger the specified actions of the source network policies 114 and/or the destination network policies 116 with respect to the received communication packet.

The network devices 108 and 112 may identify the characteristics of the network traffic associated with criteria of the source network policies 114 and the destination network policies 116, respectively. To do this, in some cases, the network devices 108 and 112 may identify characteristics of received communication packets by retrieving the characteristics from metadata associated with the communication packets. For example, in some instances, the metadata, such as source role data 118 may be accessed from a header or other portion of the communication packet 110. The source role data 118 may correspond to a source IP address associated with the source endpoint device 102, a role a user profile associated with the source endpoint device 102, a location of the source endpoint device 102, and the like. For instance, a user may access the source endpoint device 102 by logging into a machine using user credentials that correspond to the user's role within the network 106. The user's role may specify the rights and responsibilities afforded to the user within the network 106. For example, the user's role may include a network administrator, a security administrator, a read-only operator, a helpdesk technician, a guest/vendor, a service, and the like.

In some cases, the user's role may correspond to a particular department, a job function, or job title associated with the user within an enterprise or organization. By way of example, the user's role may indicate that the user is part of an engineering department, an accounting department, a human resource department, and the like. The characteristics associated with the user's role may be identified by querying an authentication server (not shown) or other device that tracks the user's identity and actions performed on the network 106. The authentication server may also provide information to the network devices 108 and 112 related to characteristics of the source endpoint device 102 and the destination endpoint device 104, the roles of the user's associated with the source endpoint device 102 and the destination endpoint device 104, and the like.

In some implementations, the network devices 108 and/or 112 may perform deep packet inspection operations to identify characteristics of received communication packets. Such characteristics may include a particular application, particular ports, certificate and/or secure hash algorithm (SHA) exchanges, universal resource locators (URLs) and/or Server Name Identification (SNI) accesses, and/or a particular version of Transport Layer Security (TLS) and/or Secure Sockets Layer (SSL) associated with the communication packet. These identified characteristics may be used, for example, to identify whether network policy criteria are met and/or to identify expected properties of network traffic within the network 106.

With the foregoing in mind, in some instances, the source network policies 114 and the destination network policies 116 may not exist and may be generated from scratch. However, there may be challenges related to defining each of the rules of the network policy when initializing communication between devices within a network. As such, the current techniques include employing the policy management system 122 to generate a proposed network policy for the network 106. The policy management system 122 may be implemented via hardware (e.g., electronic circuitry) or a combination of hardware and programming (the combination comprising, e.g., at least one processor and instructions executable by at least one processing resource 123 and stored on at least one machine-readable storage medium or storage component 125) to perform certain operations described herein.

For instance, the policy management system 122 may monitor various communication packets transmitted between various source and destination endpoint devices via various network devices over a period of time (e.g., monitoring period, thirty days). The transmitted communication packets may be tracked by network devices receiving the communication packets that may route the communication packet to some destination endpoint device. For instance, the network device 112 may receive the communication packet 110 for routing to the destination endpoint device 104.

After receiving the communication packet 110, the network device 112 may parse the communication packet 110 to identify the source role data 118 that may be embedded within the communication packet 110. In addition, the network device 112 may parse the communication packet 110 to identify the destination endpoint device 104, which may also be part of the information embedded within the communication packet 110. In some implementations, after sending the communication packet 110 to the destination endpoint device 104 or after facilitating a request provided by the communication packet 110 via the destination endpoint device 104, the network device 112 may receive a response from the destination endpoint device 104 indicative of destination role data 120. Like, the source role data 118, the destination role data 120 may correspond to an IP address associated with the destination endpoint device 104, a role associated with the destination endpoint device 104, a location of the destination endpoint device 104, and the like. In addition, the role associated with the destination endpoint device 104 may include a type of device being accessed, a type of service being accessed/requested, a type of request being facilitated, an application being executed, a type of data being accessed, and the like. Examples of the destination role data 120 may include a database server, an internal Application Programming Interface (API) gateway, an authentication server, a backup server, a management interface, a storage system, a logging server, a monitoring system, a user workstation, public Internet, guest Wi-Fi network, and the like.

After determining the source role data 118 and the destination role data 120 of the communication packet 110, the network device 112 may send the source role data 118 and the destination role data 120 to the policy management system 122 during the monitoring period. Based on the source role data 118 and the destination role data 120, the policy management system 122 may generate a network activity model 124 that may represent expected communication packets that may be transmitted between source and destination endpoint devices. In addition to the communication packets being transmitted between source and destination endpoint devices, the network activity model 124 may track the source role to destination role relationship for each transmitted communication packet. As such, the policy management system 122 may generate proposed network policies 126 that may dictate rules for facilitating requested actions (e.g., data access, data write) provided by communication packets at destination endpoint devices based on a role-to-role relationship (e.g., source role to destination role for a respective communication packet).

Indeed, during the monitoring period, the policy management system 122 may receive information related to multiple communication packets transmitted across the network 106 along with role-to-role relationship data regarding each communication packet. Based on the received information, the policy management system 122 may generate the network activity model 124 that represents the communication packets transmitted across the network 106 during the monitoring period. Assuming that each of these communication packets were valid and authorized, the policy management system 122 may generate the proposed network policies 126 based on the role-to-role relationship of each communication packet represented in the network activity model 124. That is, the proposed network policies 126 may provide a set of rules that corresponds to the communication packets transmitted via the network 106 and facilitated by various destination endpoint devices. As such, communication packets that were not transmitted during the monitoring period may not be accounted for in the proposed network policies 126. Indeed, if certain role-to-role relationships were not detected in communication packets during the monitoring period, the proposed network policies 126 may not include a rule governing the corresponding type of communication packet. As a result, the proposed network policies 126 may prohibit communication packets that are not part of the observed role-to-role relationships of communication packets during the monitoring period from being delivered or implemented.

After generating the proposed network policies 126, the policy management system 122 may send the proposed network policies 126 to other computing devices, network devices accessible to the network 106, and the like. The devices that receive the proposed network policies 126 (or the policy management system 122) may present a visualization or notification that presents the set of rules of the proposed network policies 126 for view. In some implementations, a user may provide inputs corresponding to modifications to the proposed network policies 126. As such, the user may modify certain role-to-role relationships authorized in the set of rules governing communications between devices in the network 106. In addition, the user may add additional role-to-role relationships authorized for the network 106, add additional rules that allow or prohibit certain communication types, or the like.

After receiving the user input, the policy management system 122 may store network policies 128 in a database 130 or any suitable storage component. The network policies 128 may thus include role-to-role based policies that provide source and destination role criteria for allowing the source endpoint device 102 to have access to the destination endpoint device 104. In some cases, the network devices 108 and 112 may retrieve the network policies 128 and save them as the source network policies 114 and the destination network policies 116. In the same manner, the policy management system 122 may send the network policies 128 to the network devices 108 and 112 after they are generated.

In some implementations, the policy management system 122 may continue to monitor the communication packets transmitted via the network 106 after generating the network policies 128. If the policy management system 122 detects a threshold number of rejected communication packets or other continued violations of the network policies 128, the policy management system 122 may update the network policies 128 in accordance with techniques described herein.

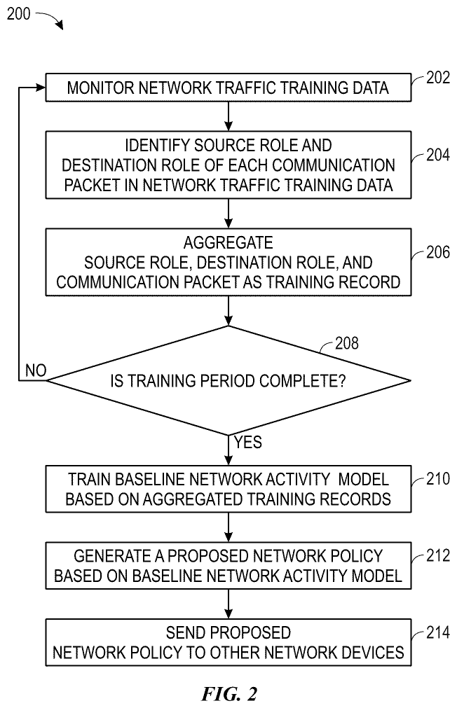

FIG. 2 illustrates a method 200 for generating a proposed network policy, in accordance with techniques described herein. In some implementations, the method 200 may be performed by the policy management system 122, however, it should be noted that the method 200 may be performed by any suitable processing system of any suitable device communicatively coupled to a network and in any suitable order.

Referring now to FIG. 2, at block 202, a policy management system that may be connected to a network of devices via a network, such as the network 100, may receive and/or monitor network traffic training data from the network devices. The network traffic training data may include a collection of communication packets (e.g., data packets, network packets) that may be transmitted between endpoint devices, such as client devices, servers, workstations, storage components, databases, servers, and the like. The network traffic training data may include information related to various communication packets transmitted from certain source endpoint devices for fulfillment by certain destination endpoint devices. The communication packets may correspond to certain requests to retrieve data, access data, view data, write data, and other data-related tasks associated with a corresponding destination endpoint device.

The network traffic training data may be received by certain network devices, such as access points, routers, and the like. These network devices may receive communication packets that originate from source endpoint devices and are addressed to a destination endpoint devices associated with the respective network devices. The network devices may parse the received communication packets to identify source role data associated with the source endpoint device. The source role data may correspond to a type of device that sent the communication packet, a department or part of an organization affiliated with equipment that sent the communication packet, a user role of a user that initiated the transmission of the communication packet, and the like.

In the same manner, the network devices may determine a destination role associated with a communication packet based on a type of dataset being accessed by the communication packet, a type of device being accessed by the communication packet, a department or part of an organization being accessed by the communication packet, and the like. With this in mind, the network devices that receive communication packets may send source role data and destination role data associated with each communication packet to the policy management system.

At block 204, the policy management system may identify the source role and the destination role of each communication packet corresponding to the network traffic training data based on the information provided by various network devices in the network. In some cases, the policy management system may generate a table to record each communication packet detected in the network traffic training data along with corresponding source role data and destination role data.

At block 206, the policy management system may aggregate the source roles, the destination roles, and information related to the corresponding communication packets detected in the network traffic training data as a training record. For instance, the policy management system may aggregate information that tracks the source role to destination role relationship (role-to-role relationship) of each communication packet detected in the network traffic training data over the period of time.

At block 208, the policy management system may determine whether a training period is complete. In some cases, the training period may be pre-defined by a user as a certain amount of time, a number of communication packets, or other measurable value. For instance, the training period may correspond to a number of minutes, hours, days, weeks, months, years, and the like. If the training period is not complete, the policy management system may return to block 202 and continue to receive network traffic training data to aggregate the training record.

If, however, the training period is complete, the policy management system may proceed to block 210 and train a baseline network activity model based on the aggregated training records. That is, the policy management system may track each of the communication packets listed in the training record and generate the baseline network activity model that indicates the role-to-role relationship for each communication packet of the network traffic training data. The baseline network activity model may include a statistical or heuristic model that tracks the different communication packets of the network traffic training data with respect to the role-to-role relationships. In some cases, the policy management system may generate graph models that illustrate the communication packets routing paths along with the role-to-role relationships.

After training the baseline network activity model, the policy management system may, at block 212, generate a proposed network policy based on the baseline network activity model. The proposed network policy may provide a set of rules that govern how network devices may facilitate requests provided by communication requests with respect to the corresponding role-to-role relationships. That is, if the baseline network activity model indicates that communication packets that request access from an engineering department to datasets associated with a supply department was part of the network traffic training data, the proposed network policy may include a rule that allows similar communication packets with similar access requests to be granted when the communication packets have similar role-to-role relationships as the network traffic training data.

After generating the proposed network policy, the policy management system may, at block 214, send the proposed network policy to different network devices. These network devices may store the proposed network policy for management communications between source and destination endpoint devices. As such, the network devices may manage communications between source and destination endpoint devices according to network policies generated based on the network traffic training data. In this way, network policies may be initialized or generated from scratch based on the network traffic training data during a monitoring period, thereby allowing users to generate network policies in an efficient manner.

Although the method 200 enables a user to generate network policies efficiently, the network traffic training data may not include certain communications that the user may intend to allow or may include certain communications that the user may not intend to allow. As such, in some cases, the proposed network policy may be provided to a user terminal or computing device, such that a user may modify the proposed network policy to incorporate these changes.

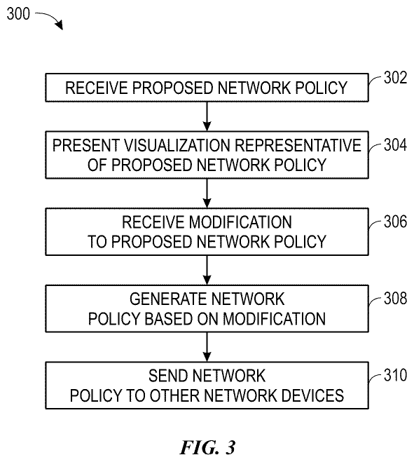

FIG. 3 illustrates a method 300 for modifying a proposed network policy, in accordance with techniques described herein. In some implementations, the method 300 may be performed by the policy management system 122 and implemented in the network 100, however, it should be noted that the method 300 may be performed by any suitable processing system of any suitable device communicatively coupled to a network. In addition, although the method 300 is described as being performed in a particular order, it should be understood that the method 300 may be performed in any suitable order.

Referring to FIG. 3, at block 302, the policy management system may receive a proposed network policy, such as the proposed network policy generated in accordance with the method 200 described above. At block 304, the policy management system may present a visualization representative of the proposed network policy. The visualization may include a list of rules that correspond to types of communication packets that are deemed authorized or allowed relative to the source role and the destination role (role-to-role relationship) of the respective communication packet. That is, each rule may specify that a certain type of communication packet (e.g., requesting read access, write access) is authorized for implementation by a network device when a particular combination of source role criteria and destination role criteria of the respective communication packet is met.

The visualization may be presented via a graphical user interface (GUI) or other interactive component that may receive inputs to modify a rule, add a rule, remove a rule, and the like. As such, at block 306, the policy management system may receive a modification to the rules presented in the visualization. In some embodiments, the policy management system may employ machine learning algorithms to identify modifications to recommend for the user based on existing network policies. That is, the machine learning algorithm may review a number of network policies to determine role-to-role relationships that are allowed and prohibited for different communication packets of other networks. After identifying more than a threshold percentage of the network policies having the same rule or a modified version of one of the rules depicted in the list of rules of the visualization, the policy management system may present a notification recommending the additional or modified rule to the user.

At block 308, after receiving the inputs from the user modifying, adding, or deleting the rules of the proposed network policy, the policy management system may generate the network policy based on the modifications. The generated network policies may correspond to the set of rules that the network devices of a corresponding network may implement to control the transmission of communication packets between source and destination endpoint devices.

After generating the network policies, at block 310, the policy management system may send the network policies to other network devices. The network devices may store the network polices, such that they may manage communication between source and destination endpoint devices based on the stored network policies. In some implementations, the network devices may then replace previously stored network policies with the network policies generated at block 308. As such, the network policies enforced by the network devices may be dynamically updated based on updated network training data, changes provided by a user, and the like.

In some cases, the network policies of the network devices may be updated over time based on monitored changes in network traffic. For instance, a network device may record information related to communication packets rejected by a respective network policy over a period of time. If the network device detects a threshold number of the same types of rejected communication packets, the network device may send a request to the policy management system to generate an updated network policy in view of the rejected communication packets. In some implementations, the policy management system may employ machine learning algorithms to determine whether rejected communication packets should be authorized in existing network policies based on patterns and other aspects of different network policies.

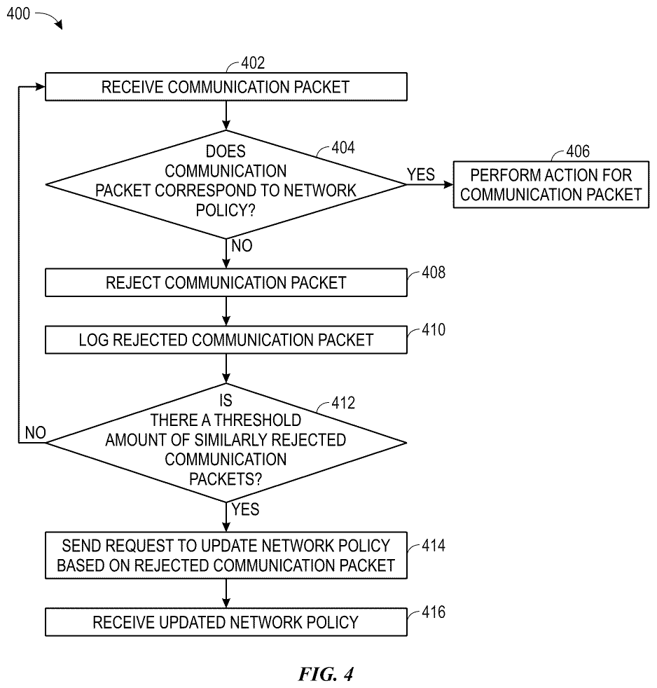

FIG. 4 illustrates a method 400 for updating the network policy based on rejected communication packets. In some implementations, the method 400 may be performed by the network device 108 and/or 112 and implemented by the network 100, however, it should be noted that the method 400 may be performed by any suitable processing system of any suitable device communicatively coupled to a network. In addition, although the method 400 is described as being performed in a particular order, it should be understood that the method 400 may be performed in any suitable order.

Referring now to FIG. 4, at block 402, the network device may receive a communication packet. The communication packet may originate from a source endpoint device and may be addressed to a destination endpoint device. As such, the network device may determine whether the destination endpoint device is authorized to receive the communication packet based on a corresponding network policy.

At block 404, the network device may determine whether the communication packet corresponds to the network policy. In some cases, the network policy may be generated based on the methods 200 and/or 300 described above. The rules of the network policy may dictate the types of communication packets that the respective destination endpoint device is authorized to receive based on a role-to-role relationship between the source endpoint device and the destination endpoint device. As such, the network device may determine the source role data of the communication packet by analyzing the packet. The network device may determine the destination role data of the destination endpoint device based on information provided to the network device from the destination endpoint device.

If the role-to-role relationship meets the rules specified for communication packets in the network policy, the network device may proceed to block 406 and perform some action based on the communication packet. That is, the network device may permit the transmission of the communication packet to the destination endpoint device, perform an action specified by the communication packet with respect to the destination endpoint device, and the like.

If, however, the role-to-role relationship does not meet the rules specified for communication packets in the network policy, the network device may proceed to block 408 and reject the communication packet. As such, the network device may delete the communication packet from its buffer or memory, such that it disregards the communication packet. In some implementations, the network device may send a message back to the source endpoint device indicating that the communication packet was rejected in view of its network policy. The communication packet may be rejected in view of the role-to-role relationship not meeting the specified rules of the network policy, the type of communication packet being prohibited according to the network policy, and the like.

At block 410, the network device may log or record the rejected communication packet in a table, storage component, or the like. The log may include details related to the role-to-role relationship associated with the rejected communication packet, the type of communication packets being rejected, and other information associated with the communication packet, the source role, the destination role, and the like.

At block 412, the network device may determine whether a threshold number of similarly rejected communication packets have been logged or recorded. That is, in some instances, a threshold number of communication packets being rejected due to a particular source role not being included in the network policy may cause the network device to proceed to block 414.

At block 414, the network device may send a request to the policy management system to update the network policy based on the rejected communication packets. The policy management system may receive the rejected communication packets, and the relevant information related to the content of the rejected communication packet, the role-to-role relationship of the communication packet, and the like to determine whether to update the network policy to authorize the rejected communication packets. In some implementations, the policy management system may retrain the network activity model as described above by monitoring the network traffic of the respective network device for an additional period of time and perform the method 200 and/or the method 300 to update the network policy. In some instances, the policy management system may retrieve additional network policies implemented by other network devices outside their respective network to determine whether the rejected communication packets should be authorized based on trends, patterns, and other properties identified using machine learning algorithms analyzing the additional network policies. In response to determining that more than a threshold percentage of the additional network policies permit the rejected communication packets, the policy management system may update the network policy of the respective network device that rejected the communication packet to authorize the role-to-role relationship for the rejected communication packet.

In some implementations, the policy management system and/or the network device may send a request to user device to accept the updated network policy that authorizes the rejected communication packet in an updated network policy. The user device may present a visualization that may receive user inputs to accept the authorization, reject the authorization, modify the authorization, or the like as discussed above.

At block 416, the network device may receive the updated network policy and store the network policy in a respective storage component. As such, the updated network policy may replace the previously stored network policy. In addition, the network device may then employ the updated network policy for controlling access to the destination endpoint device.

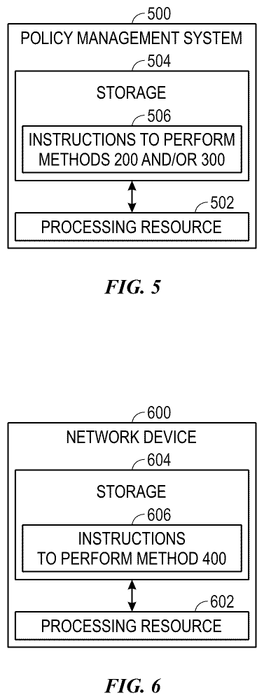

FIG. 5 illustrates components of an example policy management system 500 that may include a processing resource 502 and a storage 504. The processing resource 502 may include at least one processing resource and may access computer-readable instructions 506 that may be stored in the storage 504. The processing resource 502 may execute the computer-readable instructions 506 which may correspond to the method 200 and/or 300 described above.

The storage 504 may be any suitable article of manufacture that may serve as media to store processor-executable code, data, or the like. These articles of manufacture may represent computer-readable medium/media (i.e., any suitable form of memory or storage) that may store the processor-executable code used by processing resources to perform the presently disclosed techniques. The storage 504 may represent non-transitory computer-readable medium/media (e.g., any suitable form of memory or storage) that may store the processor-executable code used by the processing units to perform various techniques described herein. It should be noted that non-transitory merely indicates that the media is tangible and not a signal.

FIG. 6 illustrates components of an example network device 600 that may include a processing resource 602 and a storage 604. The processing resource 602 may include at least one processing resource and may access computer-readable instructions 606 that may be stored in the storage 604. The processing resource 602 may execute the computer-readable instructions 606 which may correspond to the method 400 described above.

The storage 604 may be any suitable article of manufacture that may serve as media to store processor-executable code, data, or the like. These articles of manufacture may represent computer-readable medium/media (i.e., any suitable form of memory or storage) that may store the processor-executable code used by processing units to perform the presently disclosed techniques. The storage 604 may represent non-transitory computer-readable medium/media (e.g., any suitable form of memory or storage) that may store the processor-executable code used by the processing resources to perform various techniques described herein. It should be noted that non-transitory merely indicates that the media is tangible and not a signal.

As may be appreciated, the current techniques provide improvements in managing network policies for regulating the transmission of communication packets across a network to ensure the security of the network. In contrast to other network policies that govern communications based on either a source role or a destination role without regard to a relationship between the two, the current techniques automatically generate a network policy based on a role-to-role relationship between source and destination endpoint devices of a communication. That is, the current techniques include monitoring network traffic between source and destination endpoint devices within a network for a period of time and generating a network policy based on the monitored network traffic. The monitored network traffic may include information related to the various communications facilitated by the network between source and destination endpoint devices (e.g., client devices, network devices, source devices, destination devices), as well as a role associated with each pair of source and destination endpoint devices of a respective communication. For example, upon connecting to the network, the source endpoint device may be associated with a source role, which may be a default role or some other role pre-defined by the source endpoint device. Each communication may also include a request to perform some operation (e.g., data access) via the network device. The request and the corresponding operation request provided by the source endpoint device to the network device may be associated with a destination role. As such, the monitored network traffic may include information related to a source role and a destination role for each communication facilitated by the network. This monitored network traffic may then be used to generate a network policy that provides rules for governing network communication between source and destination endpoint devices within the network based on a role-to-role relationship of a particular communication.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A system, comprising:
a storage component comprising computer-executable instructions; and
at least one processing resource configured to execute the computer-executable instructions and cause the at least one processing resource to:
monitor network traffic data over a period of time, wherein the network traffic data comprises:
one or more source roles associated with one or more source endpoint devices transmitting one or more communication packets via network; and
one or more destination roles associated with one or more destination endpoint devices configured to receive the one or more communication packets via the network;
generate a network policy based on the monitored network traffic data, wherein the network policy comprises a set of rules governing one or more access rights of the one or more source endpoint devices with respect to accessing the one or more destination endpoint devices based on relationship between a source role and a destination role of each of the one or more communication packets; and
send the network policy to one or more network devices, wherein the one or more network devices are configured to facilitate one or more requests received from the one or more source endpoint devices to access the one or more destination endpoint devices based on the network policy; and
receive a plurality of communication packets after the period of time expires;
reject at least a portion of the plurality of communication packets based on the network policy: and
send a request to the at least one processing resource to update the network policy based on the at least a portion of the plurality of communication packets, wherein the portion is greater than a threshold.

2. The system of claim 1, wherein the computer-executable instructions cause the at least one processing resource to:
train a network activity model based on the network traffic data;
generate a proposed network policy based on the network activity model;
receive one or more changes to the proposed network policy; and
generate the network policy based on the one or more changes.

3. The system of claim 1, wherein the one or more source roles are determined based on one or more user profiles associated with the one or more source endpoint devices, one or more locations associated with the one or more source endpoint devices, or both.

4. The system of claim 1, wherein the one or more source roles are embedded in the one or more communication packets.

5. The system of claim 1, wherein the one or more destination roles are determined based on one or more data types being accessed by the one or more communication packets, one or more types of devices being accessed by the one or more communication packets, or both.

6. The system of claim 1, wherein the at least one processing resource is configured to receive the network traffic data from the one or more network devices.

7-8. (canceled)

9. The system of claim 1, wherein the one or more communication packets are configured to access the one or more destination endpoint devices via the one or more network devices.

10. A non-transitory, computer-readable medium comprising computer-executable instructions that, when executed, are configured to cause at least one processing resource to:
monitor network traffic data associated with one or more communication packets transmitted from one or more source endpoint devices to one or more destination endpoint devices via a network over a period of time, wherein the network traffic data comprises:
one or more source roles associated with the one or more source endpoint devices connecting to the network; and
one or more destination roles associated with the one or more destination endpoint devices;
generate a network policy based on the monitored network traffic data, wherein the network policy comprises a set of rules governing one or more access rights of the one or more source endpoint devices with respect to accessing the one or more destination endpoint devices based on a relationship between a source role and a destination role of each of the one or more communication packets; and
send the network policy to one or more network devices, wherein the one or more network devices are configured to manage one or more access requests to the one or more destination endpoint devices received from the one or more source endpoint devices based on the network policy;
receive information associated with a plurality of rejected communication packets; and
update the network policy based on the at least a portion of the plurality of communication packets.

11. The non-transitory, computer-readable medium of claim 10, wherein the computer-executable instructions cause the at least one processing resource to:
send the network policy to a computing device;
receive one or more changes to the network policy from the computing device;
generate an updated network policy based on the one or more changes; and
send the updated network policy to the one or more network devices.

12. The non-transitory, computer-readable medium of claim 10, wherein the one or more source roles for the one or more communication packets determined based on one or more user profiles, one or more location of the one or more source endpoint devices, or both.

13. The non-transitory, computer-readable medium of claim 10, wherein the one or more destination roles for the one or more communication packets are determined based on one or more data types being accessed by the one or more communication packets, one or more types of devices being accessed by the one or more communication packets, or both.

14. (canceled)

15. A method, comprising:
monitoring network traffic data associated with one or more communication packets transmitted from one or more source endpoint devices to one or more destination endpoint devices via a network over a period of time, wherein the network traffic data comprises:
one or more source roles associated with the one or more source endpoint devices connecting to the network; and
one or more destination roles associated with the one or more destination endpoint devices;
generating a network policy based on the monitored network traffic data, wherein the network policy comprises a set of rules governing one or more access rights of the one or more source endpoint devices with respect to accessing the one or more destination endpoint devices based on a relationship between a source role and a destination role of each of the one or more communication packets;
sending the network policy to one or more network devices, wherein the one or more network devices are configured to manage one or more access requests to the one or more destination endpoint devices received from the one or more source endpoint devices based on the network policy;
receiving information associated with a plurality of rejected communication packets; and
updating the network policy based on the at least a portion of the plurality of communication packets.

16. The method of claim 15, comprising:
sending the network policy to a computing device;
receiving one or more changes to the network policy from the computing device;
generating an updated network policy based on the one or more changes; and
sending the updated network policy to the one or more network devices.

17. The method of claim 15, wherein the one or more source roles for the one or more communication packets are determined based on one or more user profiles associated with the one or more source endpoint devices, one or more locations of the one or more source endpoint devices, or both.

18. The method of claim 15, wherein the one or more destination roles for the one or more communication packets are determined based on one or more data types being accessed by the one or more communication packets, one or more types of devices being accessed by the one or more communication packets, or both.

19. (canceled)

20. The method of claim 15, wherein the network policy is updated based on a machine learning algorithm and a plurality of network policies.
